(19) United States
(12) Patent Application Publication
(10) Pub. No.: US 2025/0076745 A1
(43) Pub. Date: Mar. 6, 2025

(54) OPTICAL ENGINE MODULE AND PROJECTOR

(71) Applicant: Coretronic Corporation, Hsin-Chu (TW)

(72) Inventors: Wen-Ching Ho, Hsin-Chu (TW); Ken-Teng Peng, Hsin-Chu (TW)

(73) Assignee: Coretronic Corporation, Hsin-Chu (TW)

(21) Appl. No.: 18/817,195

(22) Filed: Aug. 27, 2024

(30) Foreign Application Priority Data
Aug. 31, 2023 (CN) 202322353022.3

(51) Int. Cl. G03B 21/14; G03B 21/20

(52) U.S. Cl. CPC G03B 21/145; G03B 21/2033

(57) ABSTRACT

An optical engine module configured to receive an illumination beam includes a casing, a light uniforming element, an optical lens element, an elastic member, and a light valve. The casing has an accommodating space. The light uniforming element, the optical lens element, and the elastic member are disposed in the accommodating space. The optical lens element is disposed adjacent to a light exit end of the light uniforming element. The elastic member surrounds at least part of an outer periphery of the optical lens element. The elastic member is sealingly disposed in a gap between the optical lens element and the casing to separate the accommodating space into a first chamber and a second chamber, in which the light uniforming element is positioned in the first chamber. The illumination beam passes through the light uniforming element and the optical lens element sequentially and is transmitted to the light valve.

### CROSS-REFERENCE TO RELATED APPLICATION

This application claims the priority benefit of China application serial no. 202322353022.3, filed on Aug. 31, 2023. The entirety of the above-mentioned patent application is hereby incorporated by reference herein and made a part of this specification.

### BACKGROUND

### Technical Field

The disclosure relates to an optical engine module, and in particular to a projector using the optical engine module.

### Description of Related Art

Currently, when color wheel modules are used with the monolithic digital light processing (DLP), the projector is prone to produce the rainbow effect, which is the phenomenon that some users see the three primary colors of red, green, and blue similar to a rainbow in the projected image, and the phenomenon is also referred to as the color break-up (CBU). The color wheel module uses a spinning frequency that is higher than the reaction time of the human eye to present full color effect, nevertheless, in high-speed moving images, the three primary color lights of red, green, and blue may have been destroyed by the next frame before forming an image in the retina in time, resulting in the color break-up phenomenon at the edges of objects in the image.

Regarding the above problem, currently, the so-called rainbow effect is improved by increasing the speed of the color wheel module. However, whilst increasing the speed of the color wheel module, inevitably, the color wheel module is prone to generate the noise, and the noise could even be transmitted to the entire projector, thus failing to meet the predetermined specifications.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an optical engine module, which can avoid the noise of the color wheel module when in the high speed.

The disclosure provides a projector, which includes the optical engine module.

Other purposes and advantages of the disclosure may be further understood from the technical features disclosed in the disclosure.

In order to achieve one, a part of, or all of the above purposes or other purposes, the disclosure provides an optical engine module configured to receive an illumination beam, and the optical engine module includes a casing, a light uniforming element, an optical lens element, an elastic member, and a light valve. The casing has an accommodating space, and the light uniforming element, the optical lens element, and the elastic member are disposed in the accommodating space. The optical lens element is disposed adjacent to a light exit end of the light uniforming element. The elastic member surrounds at least part of an outer periphery of the optical lens element. The elastic member is sealingly disposed in a gap between the optical lens element and the casing to separate the accommodating space into a first chamber and a second chamber, in which the light uniforming element is positioned in the first chamber. The illumination beam passes through the light uniforming element and the optical lens element sequentially and is transmitted to the light valve.

In order to achieve one, a part of, or all of the above purposes or other purposes, the disclosure provides a projector including a light source module, a projection lens, and the optical engine module. The light source module is configured to provide an illumination beam. The optical engine module is configured to receive the illumination beam from the light source module. The light valve is configured to convert the illumination beam into an image beam. The projection lens is positioned on a transmission path of the image beam from the light valve and configured to emit the image beam from the projector.

Based on the above, the embodiments of the disclosure have at least one of the following advantages or effects. In the projector according to the disclosure, the elastic member is sealingly disposed in the gap between the optical lens element and the casing, thereby blocking the noise from being transmitted to the entire projector.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projector according to an embodiment of the disclosure.

FIG. 2A is a schematic perspective view of the projector in FIG. 1.

FIG. 2B is a partially enlarged schematic view of the projector in FIG. 2A.

FIG. 3 is a top view of the projector in FIG. 2A.

FIG. 4 is a cross-sectional view of the projector in FIG. 2A along a cross-section line A-A′.

FIG. 5A is a cross-sectional view of the projector in FIG. 2A along a cross-section line B-B′.

FIG. 5B is an enlarged schematic view in a region R1 of the projector in FIG. 5A.

FIG. 6A is a perspective view of an elastic member in FIG. 5A.

FIG. 6B is a perspective view of the elastic member in FIG. 6A from another viewing angle.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

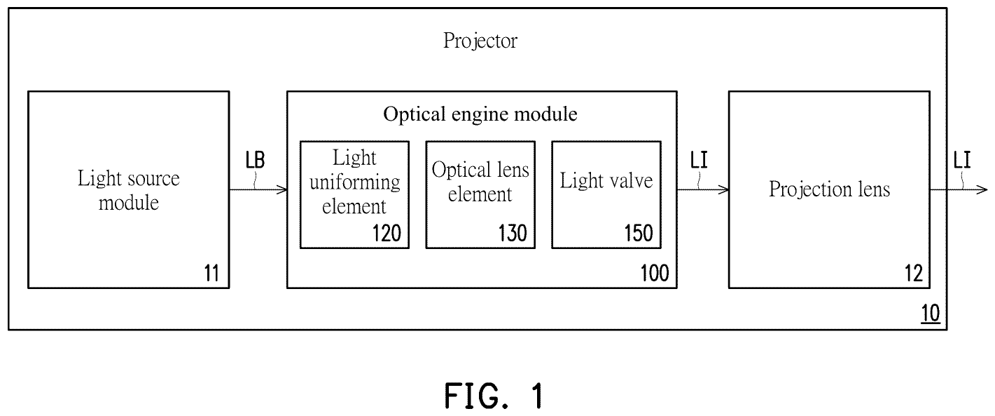

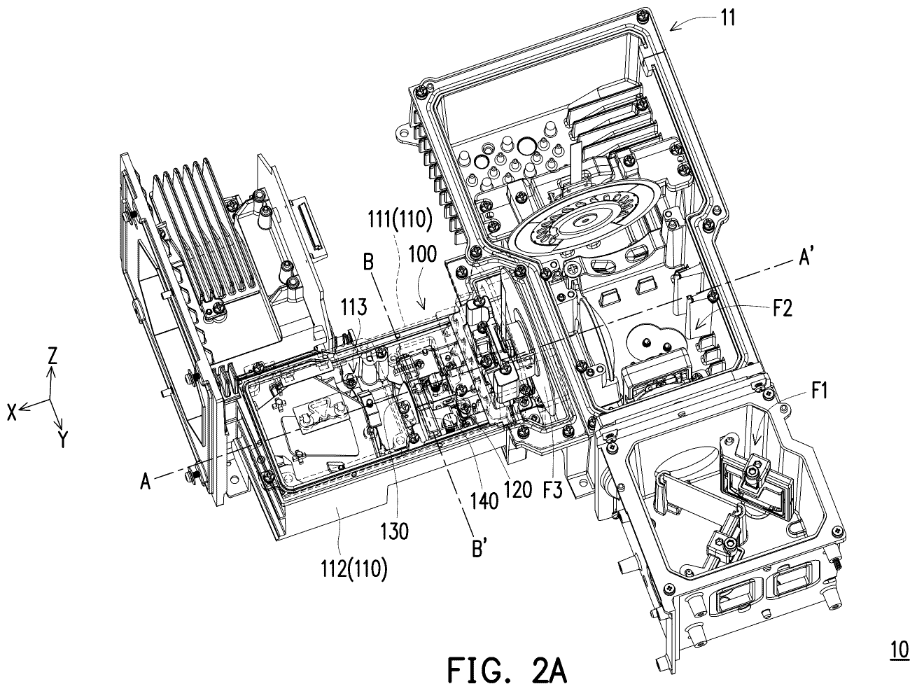

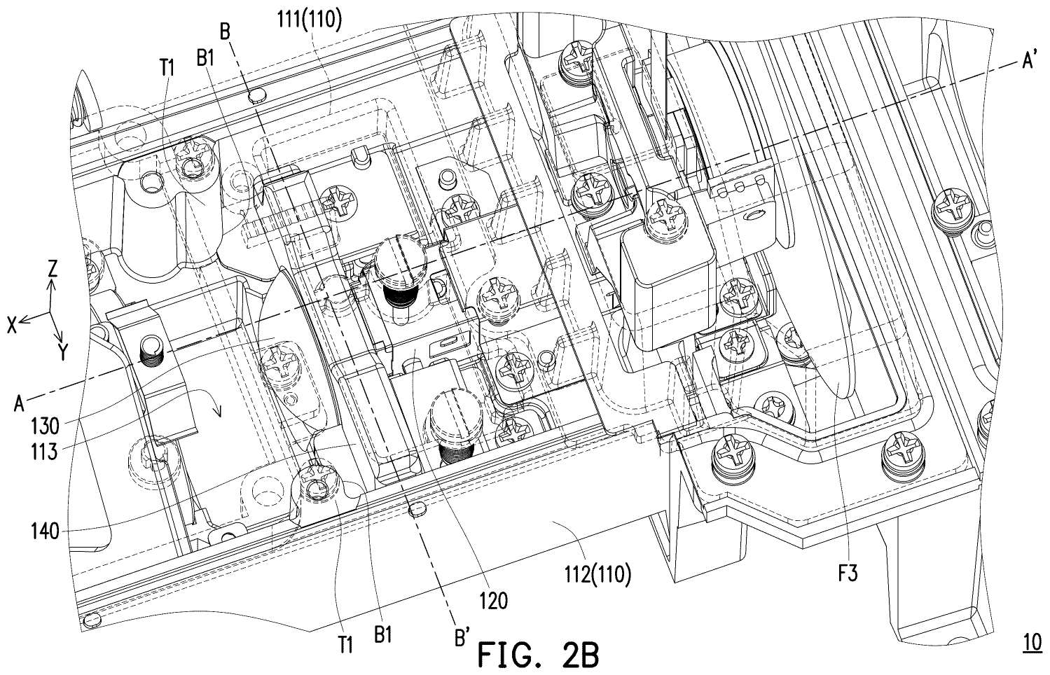

FIG. 1 is a schematic view of a projector according to an embodiment of the disclosure. FIG. 2A is a schematic perspective view of the projector in FIG. 1. FIG. 2B is a partially enlarged schematic view of the projector in FIG. 2A. It should be noted that X direction, Y direction and Z direction are marked in FIG. 2A and FIG. 2B to show the disposed relationship of each component in the drawing. X direction, Y direction and Z direction intersect with each other, but are not limited thereto. Some irrelevant structures in FIG. 1, FIG. 2A and FIG. 2B will be omitted to facilitate display and identification of the component parts to be explained.

Please refer to FIG. 1 to FIG. 2B. A projector 10 of this embodiment includes a light source module 11, an optical engine module 100, and a projection lens 12. In this embodiment, the light source module 11 is configured to provide an illumination beam LB. The optical engine module 100 is configured to receive the illumination beam LB from the light source module 11. The optical engine module 100 includes a light uniforming element 120, an optical lens element 130, and a light valve 150. The light valve 150 is configured to convert the illumination beam LB into an image beam LI. The projection lens 12 is positioned on a transmission path of the image beam LI from the light valve 150 and configured to emit the image beam LI from the projector 10 to a projection target (not shown), such as a screen or a wall. Here, the projector 10 is, for example, a digital light processing (DLP) projector, but the disclosure is not limited thereto. The light valve 150 is, for example, a reflective light modulator such as a liquid crystal on silicon panel (LCOS panel) or a digital micro-mirror device (DMD). In an embodiment, the light valve 150 is, for example, a transmissive light modulator such as a transparent liquid crystal panel, an electro-optical modulator, a maganeto-optic modulator, or an acousto-optic modulator (AOM). However, this embodiment does not limit the form and type of the light valve 150. The projection lens 12 includes, for example, a combination of one or more optical lens elements with the diopter, such as various combinations of non-planar lens elements including biconcave lens elements, biconvex lens elements, meniscus lens elements, convex and concave lens elements, plano-convex lens elements, and plano-concave lens elements.

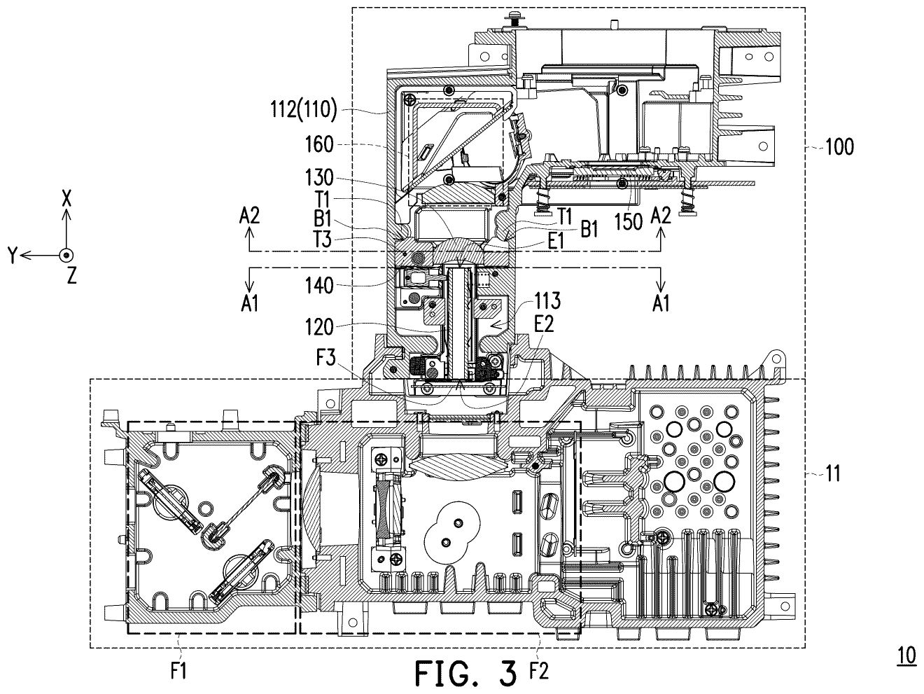

FIG. 3 is a top view of the projector in FIG. 2A. In this embodiment, further referring to FIG. 3, the light source module 11 includes a light source device F1, an optical assembly F2, and a filter module F3. The light source device F1 is configured to emit a laser beam (not shown), and the optical assembly F2 is disposed on an optical path of the laser beam between the light source device F1 and the filter module F3. In this embodiment, the light uniforming element 120 is, for example, an integration rod, in other embodiments, the light uniforming element 120 may be other suitable forms of optical elements, such as a fly eye lens array, and the disclosure is not limited thereto. The light uniforming element 120 includes a light exit end El and a light entrance end E2 opposite to each other, the filter module F3 is disposed adjacent to the light entrance end E2 of the light uniforming element 120, the laser beam emitted by the light source device F1 passes through the optical assembly F2 and the filter module F3 sequentially, and the light uniforming element 120 is positioned between the optical lens element 130 and the filter module F3. It should be noted that, in an embodiment, the optical assembly F2 includes, for example, a phosphor wheel, which is configured to reflect the laser beam from the light source device F1 at different timings and convert the laser beam into at least one excited beam of different wavelength, and the color of the at least one excited beam of different wavelength is different from the color of the laser beam. Therefore, when the laser beam emitted by the light source device F1 is transmitted to the optical assembly F2, the illumination beam LB is formed by the optical assembly F2, and the illumination beam LB includes the laser beam or/and the at least one excited beam of different wavelength. In addition, the filter module F3 includes, for example, a color filter wheel, but the disclosure is not limited thereto.

Generally speaking, the synchronous speed of the phosphor wheel and color filter wheel of a conventional DLP projector is 2 times the speed of 7200 rpm (revolution per minutes), which is prone to produce the rainbow effect. In order to improve the rainbow effect of the DLP projector, the synchronous speed of the phosphor wheel and color filter wheel sometimes needs to reach 3 times the speed of 10800 rpm or 4 times the speed of 14400 rpm, causing the noise to occur. The optical engine module according to the disclosure can isolate the noise, so that the noise is not transmitted to the entire projector.

In this embodiment, the optical engine module 100 also includes a casing 110 and an elastic member 140. The optical lens element 130 is, for example, a condenser lens element, but the disclosure is not limited thereto.

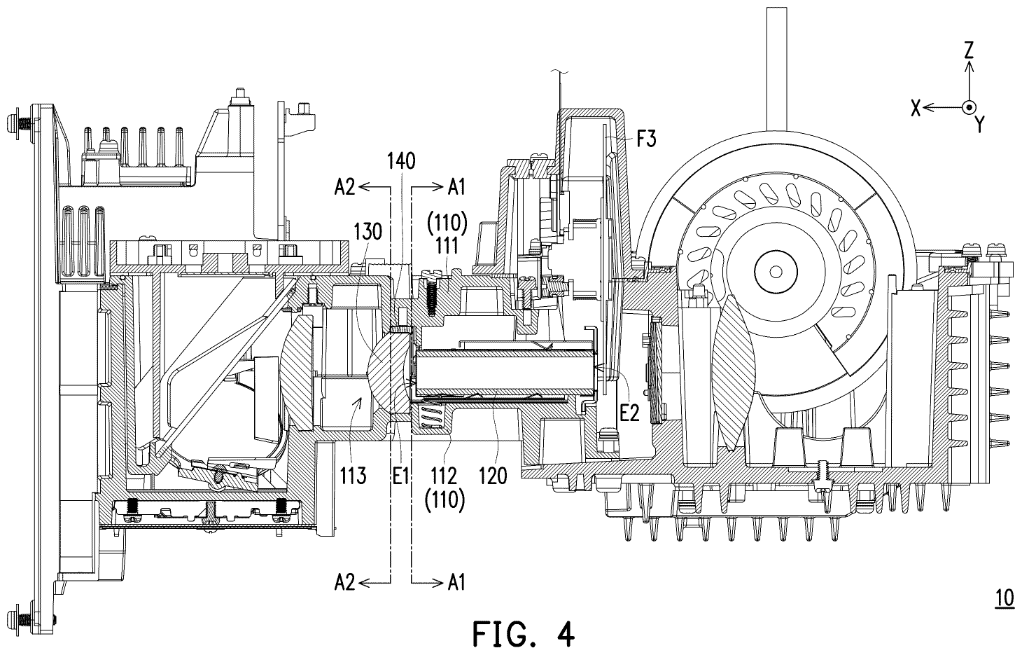

FIG. 4 is a cross-sectional view of the projector in FIG. 2A along a cross-section line A-A′. Referring to FIG. 4 together with FIG. 2A, FIG. 2B, and FIG. 3, in this embodiment, the casing 110 includes a first casing 111 and a second casing 112. The first casing 111 and the second casing 112 are assembled to form an accommodating space 113. The light uniforming element 120, the optical lens element 130, and the elastic member 140 are disposed in the accommodating space 113. The optical lens element 130 is disposed adjacent to a light exit end El of the light uniforming element 120. The elastic member 140 surrounds at least part of the optical lens element 130 and does not block the illumination beam LB (shown in FIG. 1) from passing through the optical lens element 130.

In this embodiment, the light uniforming element 120 is disposed on a transmission path of the illumination beam LB to adjust a shape of a light spot of the illumination beam LB, so that the shape of the light spot of the illumination beam LB may match a shape (for example, a rectangle) of a work region of the light valve 150, and that light intensities of portions of the light spot are consistent or close to each other, thereby the light intensity of the illumination beam LB is uniform.

Please continue to refer to FIG. 3 and FIG. 4. In this embodiment, the elastic member 140 is sealingly disposed in a gap between the optical lens element 130 and the casing 110. Therefore, the elastic member 140 and the optical lens element 130 separate the accommodating space 113 into a first chamber A1 and a second chamber A2, in which the light uniforming element 120 is positioned in the first chamber A1.

Please continue to refer to FIG. 3. In this embodiment, the optical engine module 100 further includes an optical lens element group 160. The optical lens element group 160 is disposed on an optical path of an illumination beam between the optical lens element 130 and the light valve 150 and positioned in the second chamber A2. Through the position of the optical lens element group 160, the first chamber A1 and the second chamber A2 in the accommodating space 113 are more clearly defined. The illumination beam LB from the light source module F1 passes through the light uniforming element 120, the optical lens element 130, and the optical lens element group 160 sequentially and is transmitted to the light valve 150.

Please continue to refer to FIG. 4. In this embodiment, the accommodating space 113 formed by the first casing 111 and the second casing 112 has a minimum cross-sectional area on a plane (a Y-Z plane) perpendicular to an optical axis (corresponding to an X axis) of the optical lens element 130, the optical lens element 130 and the elastic member 140 are disposed at the minimum cross-sectional area of the accommodating space 113, and the materials for making the elastic member 140 can be saved, but the disclosure is not limited thereto.

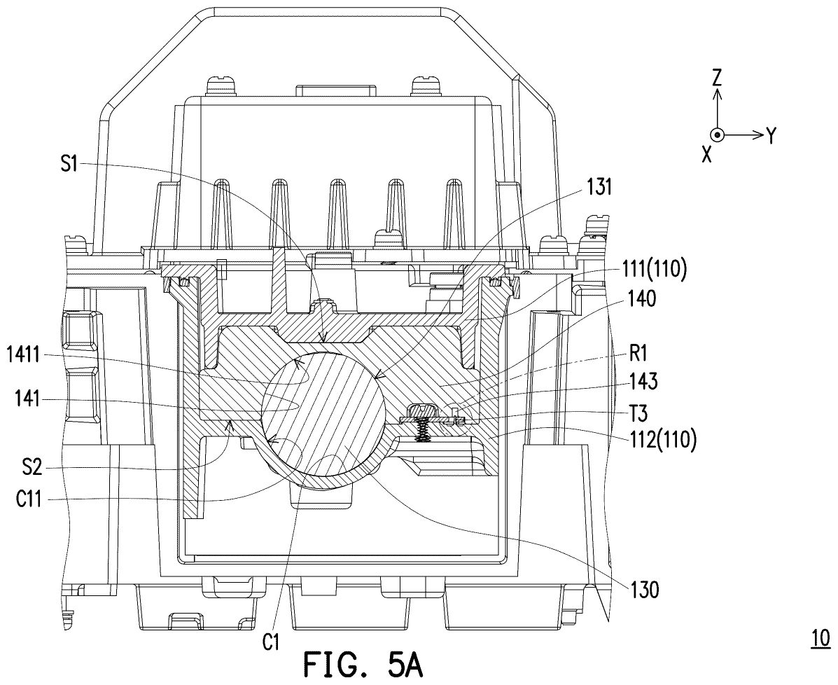

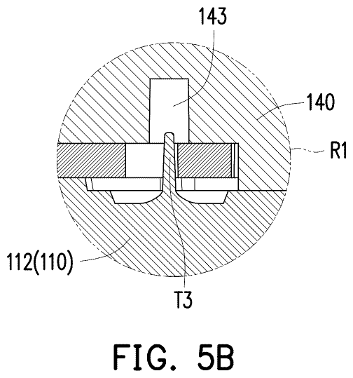

FIG. 5A is a cross-sectional view of the projector in FIG. 2A along a cross-section line B-B′. FIG. 5B is an enlarged schematic view in a region R1 of the projector in FIG. 5A. Referring to FIG. 5A, in this embodiment, the second casing 112 has a cavity C1, and a shape of an inner wall C11 of the cavity C1 matches an outer periphery 131 of the optical lens element 130, so that the optical lens element 130 is disposed corresponding to the cavity C1 of the second casing 112.

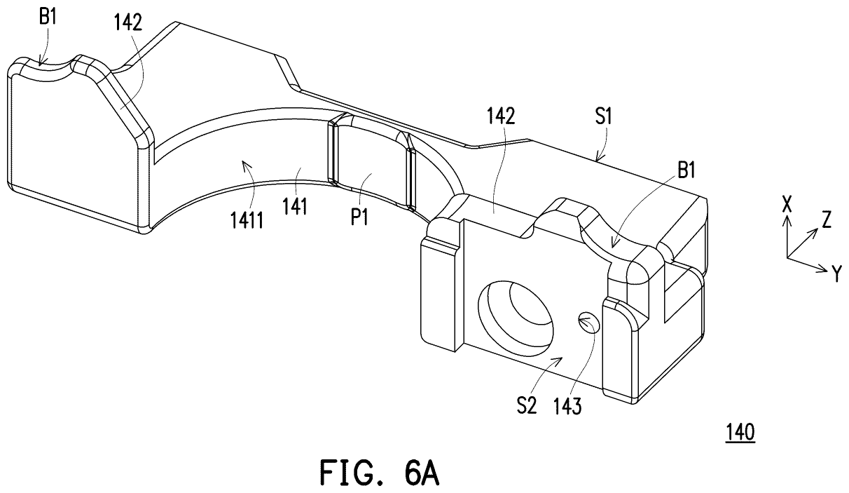

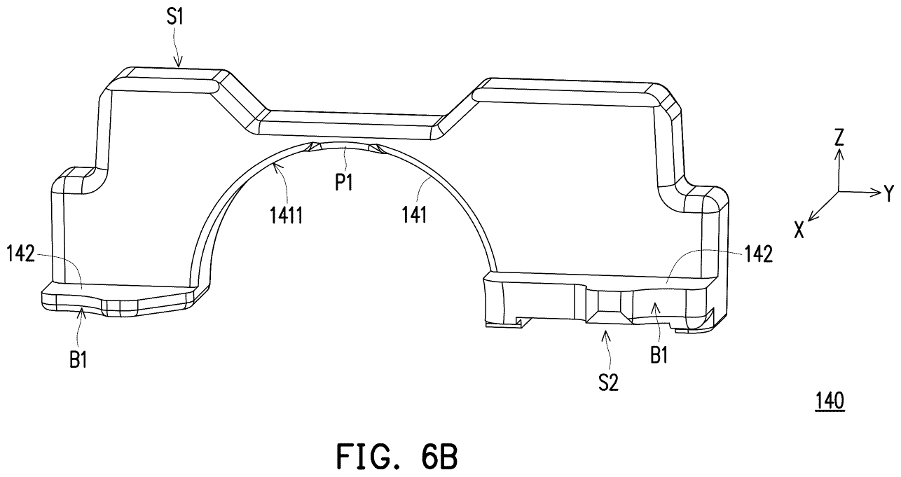

FIG. 6A is a perspective view of an elastic member in FIG. 5A. FIG. 6B is a perspective view of the elastic member in FIG. 6A from another viewing angle. Please refer to FIG. 5A, FIG. 6A, and FIG. 6B first. In this embodiment, the elastic member 140 has a first side S1 and a second side S2. The first side S1 corresponds to the first casing 111, and the second side S2 corresponds to the second casing 112. The elastic member 140 has an accommodating part 141, and at least part of the outer periphery 131 of the optical lens element 130 is in contact with the inner wall 1411 of the accommodating part 141.

Specifically, in this embodiment, the accommodating part 141 is disposed with a protrusion part P1 protruding toward the second casing 112. For example, the protrusion part P1 protrudes slightly from the inner wall 1411, but the disclosure is not limited thereto. In this embodiment, since the hardness of the elastic member 140 is smaller than the hardness of the optical lens element 130, the material of the elastic member 140 is, for example, foam or silicone rubber, and the disclosure is not limited thereto. Furthermore, the elastic member 140 is closed-cell foam, or silicone rubber that can withstand a temperature of at least 80° C., and the disclosure is not limited thereto. Therefore, when elastic member 140 is disposed between the optical lens element 130 and the first casing 111, the first side SI of the elastic member 140 is pressed by the first casing 111, the protrusion part P1 presses against a part of the at least part of the outer periphery 131 of the optical lens element 130, the protrusion part P1 interferes with the outer periphery 131, the protrusion part P1 is squeezed by the optical lens element 130, so that the optical lens element 130 and the elastic member 140 fit tightly.

Under the above disposition manner, the elastic member 140 is compressed in the gap between the optical lens element 130 and the casing 110, serving as an airtight structure and having a protective effect. In this way, when the speed of the filter module F3 increases, the spinning sound and the wind noise of the filter module F3 are blocked by the elastic member 140 and the optical lens element 130 and cannot be transmitted to the second chamber A2, which can prevent the noise from being transmitted to the entire projector, thereby achieving the effect of isolating the noise from the first chamber A1 and the second chamber A2. In addition, experiments show that, adding the airtight structure can further reduce the noise by 1 dB (A), and the noise reduction effect is improved, but the disclosure is not limited thereto.

In this embodiment, the elastic member 140 also has two extending parts 142, and the accommodating part 141 is positioned between the two extending parts 142. The two extending parts 142 of the elastic member 140 extend along the direction parallel to the optical axis (corresponding to the X axis) of the optical lens element 130. On the direction (the Z axis) perpendicular to the optical axis (corresponding to the X axis) of the optical lens element 130, the optical lens element 130 is located between the two extending parts 142, so as to prevent the extending parts 142 from blocking the light entrance region and the light exit region of the optical lens element 130. Furthermore, on the Z-axis direction, the elastic member 140 does not extend to the surroundings of the light uniforming element 120, but the disclosure is not limited thereto.

In this embodiment, the second casing 112 is disposed with two protrusion structures T1 (FIG. 2B and FIG. 3), and each of the two extending parts 142 has a fixing structure B1 to engage with the two protrusion structures T1 of the second casing 112 respectively, so that the elastic member 140 is fixed in the second casing 112 to ensure that the elastic member 140 does not move arbitrarily, thereby maintaining a good sound isolation effect.

In this embodiment, the second side S2 of the elastic member 140 has a slot 143, the second casing 112 is disposed with a protrusion column T3 (FIG. 5B), and the protrusion column T3 of the second casing 112 extends into the slot 143, so that the elastic member 140 is fixed in the second casing 112 to ensure that the elastic member 140 does not move arbitrarily, thereby maintaining a good sound isolation effect.

In this embodiment, the average thickness of the elastic member 140 between the first side S1 and the second side S2 is greater than the average thickness between the protrusion part P1 and the first side S1. That is to say, in the thickness direction (for example, the Z-axis direction), the distance between the two extending parts 142 and the first side S1 is greater than the distance between the protrusion part P1 and the first side S1. That is to say, the average thickness of the elastic member 140 in the middle region corresponding to the protrusion part P1 is smaller than the average thickness in the peripheral regions on the left and right sides of the accommodating part 141, but the disclosure is not limited thereto.

In summary, in the projector according to the disclosure, the elastic member is sealingly disposed in the gap between the optical lens element and the casing. In this way, when the speed of the filter module increases, the spinning sound and the wind noise of the filter module are blocked by the elastic member and the optical lens element and cannot be transmitted to the second chamber, which can prevent the noise from being transmitted to the entire projector, thereby achieving the effect of isolating the noise from the first chamber and the second chamber.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An optical engine module configured to receive an illumination beam, wherein the optical engine module comprises a casing, a light uniforming element, an optical lens element, an elastic member, and a light valve;
the casing has an accommodating space, and the light uniforming element, the optical lens element and the elastic member are disposed in the accommodating space; wherein
the optical lens element is disposed adjacent to a light exit end of the light uniforming element, the elastic member surrounds at least part of an outer periphery of the optical lens element, and the elastic member is sealingly disposed in a gap between the optical lens element and the casing to separate the accommodating space into a first chamber and a second chamber, wherein the light uniforming element is positioned in the first chamber, and the illumination beam passes through the light uniforming element and the optical lens element sequentially and is transmitted to the light valve.

2. The optical engine module as claimed in claim 1, wherein the casing comprises a first casing and a second casing, and the first casing and the second casing are assembled to form the accommodating space.

3. The optical engine module as claimed in claim 2, wherein the second casing has a cavity, and a shape of an inner wall of the cavity matches the outer periphery of the optical lens element, so that the optical lens element is disposed corresponding to the cavity.

4. The optical engine module as claimed in claim 2, wherein the elastic member has a first side and a second side, the first side corresponds to the first casing, the second side corresponds to the second casing, the elastic member has an accommodating part, and the at least part of the outer periphery of the optical lens element is in contact with the inner wall of the accommodating part.

5. The optical engine module as claimed in claim 4, wherein the accommodating part is disposed with a protrusion part protruding toward the second casing, and the protrusion part presses against a part of the at least part of the outer periphery of the optical lens element, so that the optical lens element and the elastic member fit tightly.

6. The optical engine module as claimed in claim 4, wherein the elastic member also has two extending parts, the second casing is disposed with two protrusion structures, the accommodating part is positioned between the two extending parts, each of the two extending parts has a fixing structure to engage with the two protrusion structures of the second casing respectively, so that the elastic member is fixed in the second casing.

7. The optical engine module as claimed in claim 6, wherein the second side of the elastic member has a slot, the second casing is disposed with a protrusion column, and the protrusion column of the second casing is connected to the slot, so that the elastic member is fixed in the second casing.

8. The optical engine module as claimed in claim 6, wherein the two extending parts of the elastic member extend along a direction parallel to an optical axis of the optical lens element.

9. The optical engine module as claimed in claim 5, wherein an average thickness of the elastic member between the first side and the second side is greater than an average thickness between the protrusion part and the first side.

10. The optical engine module as claimed in claim 1, wherein the accommodating space has a minimum cross-sectional area on a plane perpendicular to an optical axis of the optical lens element, and the optical lens element and the elastic member are disposed at the minimum cross-sectional area.

11. A projector, comprising a light source module, a projection lens, and an optical engine module as claimed in claim 1; wherein,
the light source module is configured to provide an illumination beam;
the optical engine module is configured to receive the illumination beam from the light source module;
the light valve is configured to convert the illumination beam into an image beam; and
the projection lens is positioned on a transmission path of the image beam from the light valve and configured to emit the image beam from the projector.

12. The projector as claimed in claim 11, wherein the light source module comprises a light source device, an optical assembly, and a filter module, the optical assembly is disposed between the light source device and the filter module, the filter module is disposed adjacent to a light entrance end of the light uniforming element, a laser beam emitted by the light source device passes through the optical assembly and the filter module sequentially, and the light uniforming element is positioned between the optical lens element and the filter module.
